(19) United States
(12) Patent Application Publication
(10) Pub. No.: US 2014/0215383 A1
(43) Pub. Date: Jul. 31, 2014

(54) PARALLAX SCROLLING USER INTERFACE

(71) Applicant: Disney Enterprises, Inc., Burbank, CA (US)

(72) Inventors: SYLVIA PARK-EKECS, Burbank, CA (US); ARNAUD ROBERT, Simi Valley, CA (US); KEITH TRALINS, Burbank, CA (US)

(73) Assignee: Disney Enterprises, Inc., Burbank, CA (US)

(21) Appl. No.: 13/843,469

(22) Filed: Mar. 15, 2013

Related U.S. Application Data
(60) Provisional application No. 61/758,908, filed on Jan. 31, 2013.

(51) Int. Cl. G06F 3/0485

(52) U.S. Cl. CPC G06F 3/0485
USPC 715/784

(57) ABSTRACT

A GUI having a parallax scrolling visual effect is provided. The GUI comprises multiple collections of elements. The collections comprise content elements, various foreground elements, middle ground elements, and background elements. Upon user input to display another collection of elements, the GUI transitions to the next collection by translating the content elements, including the foreground elements, middle ground elements, and background elements at different speeds, thus providing a parallax scrolling effect.

### CROSS-REFERENCE TO RELATED APPLICATIONS

This application claims the benefit of U.S. Provisional Application No. 61/758,908, filed Jan. 31, 2013.

### TECHNICAL FIELD

The present disclosure relates generally to graphical user interfaces, and more particularly, some embodiments relate to systems and methods for displaying transitions between content elements.

### Description of the Related Art

Graphical user interfaces (GUIs) for displaying content to users take a variety of forms. For example, a GUI may be used for displaying a selection of content elements such as pictures of movies, books, clothing, or other products.

### BRIEF SUMMARY

A GUI having a parallax scrolling visual effect is provided. The GUI comprises multiple collections of elements. The collections comprise content elements, various middle ground elements, and background elements. Upon user input to display another collection of elements, the GUI transitions to the next collection by translating the content elements, including the foreground elements, middle ground elements, and background elements at different speeds, thus providing a parallax scrolling effect.

Parallax scrolling may be used in interactive marketing to “bleed” or transition into another screen. The other screen may provide users access another section of a marketing campaign, which may include options such as playing video. The scrolling effect may triggered by various user interactions. For example, the effect may be triggered by a user swiping a screen, pressing a hardware or software key, or selecting elements displayed at different levels on the current screen. The scrolling effect may be used to strengthen brand experience into core-branding and sub-branding. For example, a core-branding landing screen may use the core brand elements and one of the layers that bleed into the next screen may have sub-branding elements to lead users to sub-branding pages.

Other features and aspects of the disclosure will become apparent from the following detailed description, taken in conjunction with the accompanying drawings, which illustrate, by way of example, the features in accordance with various implementations.

### BRIEF DESCRIPTION OF THE FIGURES

The figures are provided for purposes of illustration only and merely depict typical or example embodiments. They do not limit the breadth, scope, or applicability of the disclosure.

FIG. 1 illustrates an example content hosting system that may be utilized in some implementations.

FIG. 2 illustrates an example computing module that may be used to implement various features of the system and methods disclosed herein.

FIG. 3 illustrates an example user interface and method of system interaction.

FIG. 4 illustrates various aspects of the user interface illustrated in FIG. 3.

### DETAILED DESCRIPTION OF THE EMBODIMENTS OF THE DISCLOSURE

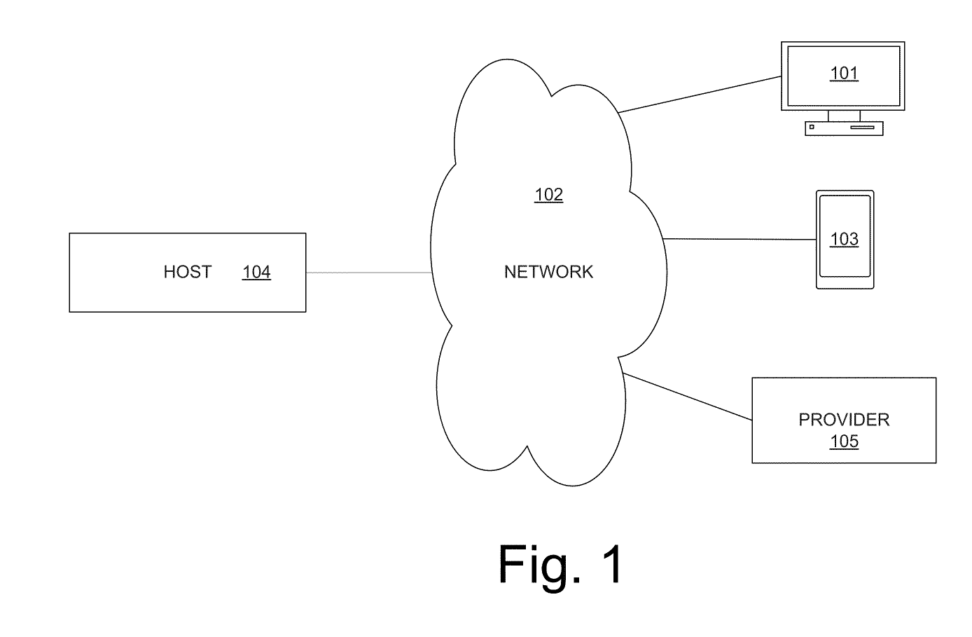

FIG. 1 illustrates an example content hosting system that may be utilized in some implementations. The system comprises a host 104, a content provider 105, and users 101, 103 on a network 102. The content provider 105 provides media content to be hosted by the host 104 and provided to the users 101, 103 over network 102. For example, the network 102 may comprise the Internet. Host 104 may comprise a server or servers providing web content, or other Internet delivered content. The users 101, 103, may comprise various computing devices, such as desktop or laptop computers, tablets, mobile phones, media players, or other network connected devices. In some embodiments, the provider 105 and the host 104 may be the same entity or may be controlled by the same entity. In a particular implementation, the provider 105 provides streaming movies and related products using the host 104 to users 101, 103.

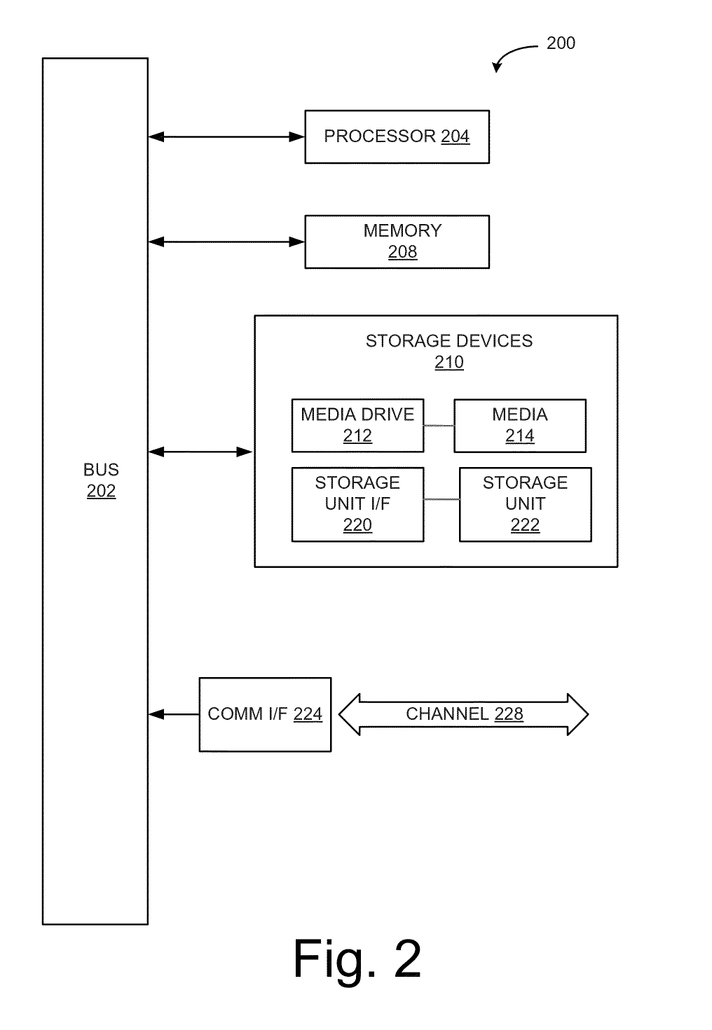

As used herein, the term module might describe a given unit of functionality that can be performed in accordance with one or more embodiments of the present application. As used herein, a module might be implemented utilizing any form of hardware, software, or a combination thereof. For example, one or more processors, controllers, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 2. Various embodiments are described in terms of this example-computing module 200. After reading this description, it will become apparent to a person skilled in the relevant art how to implement the application using other computing modules or architectures.

Referring now to FIG. 2, computing module 200 may represent, for example, computing or processing capabilities found within user devices 101, 103, host 104, or provider 105

Computing module 200 might include, for example, one or more processors, controllers, control modules, or other processing devices, such as a processor 204. Processor 204 might be implemented using a general-purpose or special-purpose processing engine such as, for example, a microprocessor, controller, or other control logic. In the illustrated example, processor 204 is connected to a bus 202, although any communication medium can be used to facilitate interaction with other components of computing module 200 or to communicate externally.

Computing module 200 might also include one or more memory modules, simply referred to herein as main memory 208. For example, random access memory (RAM) or other dynamic memory, might be used for storing information and instructions to be executed by processor 204. Main memory 208 might also be used for storing temporary variables or other intermediate information during execution of instructions to be executed by processor 204. Computing module 200 might likewise include a read only memory (“ROM”) or other static storage device coupled to bus 202 for storing static information and instructions for processor 204.

The computing module 200 might also include one or more various forms of information storage mechanism 210, which might include, for example, a media drive 212 and a storage unit interface 220. The media drive 212 might include a drive or other mechanism to support fixed or removable storage media 214. For example, a hard disk drive, a CD or DVD drive, or other removable or fixed media drive might be provided. Accordingly, storage media 214 might include, for example, a hard disk, a floppy disk, magnetic tape, cartridge, optical disk, a CD or DVD, or other fixed or removable medium that is read by, written to or accessed by media drive 212. As these examples illustrate, the storage media 214 can include a computer usable storage medium having stored therein computer software or data.

In alternative embodiments, information storage mechanism 210 might include other similar instrumentalities for allowing computer programs or other instructions or data to be loaded into computing module 200. Such instrumentalities might include, for example, a fixed or removable storage unit 222 and an interface 220. Examples of such storage units 222 and interfaces 220 can include a program cartridge and cartridge interface, a removable memory (for example, a flash memory or other removable memory module) and memory slot, a PCMCIA slot and card, and other fixed or removable storage units 222 and interfaces 220 that allow software and data to be transferred from the storage unit 222 to computing module 200.

Computing module 200 might also include a communications interface 224. Communications interface 224 might be used to allow software and data to be transferred between computing module 200 and external devices. Examples of communications interface 224 might include a network interface (such as an Ethernet, network interface card, IEEE 802.XX or other interface), a communications port (such as for example, a USB port, IR port, RS222 port Bluetooth® interface, or other port), or other communications interface. Software and data transferred via communications interface 224 might typically be carried on signals, which can be electronic, electromagnetic (which includes optical) or other signals capable of being exchanged by a given communications interface 224. These signals might be provided to communications interface 224 via a channel 228. This channel 228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 208, storage unit interface 220, storage media 214, and channel 228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 200 to perform features or functions of the present application as discussed herein.

A GUI may comprise multiple sets of content elements arranged by category. For example, the GUI may display a first set of content elements related to action films. Upon a user prompt, the GUI may display a second set of content elements related to romance films. Various visual effects may be used to enhance the experience of using the GUI. Visual effects are typically flat. Designers have tried to overcome this by using some techniques such as shadows, and manipulating perspective.

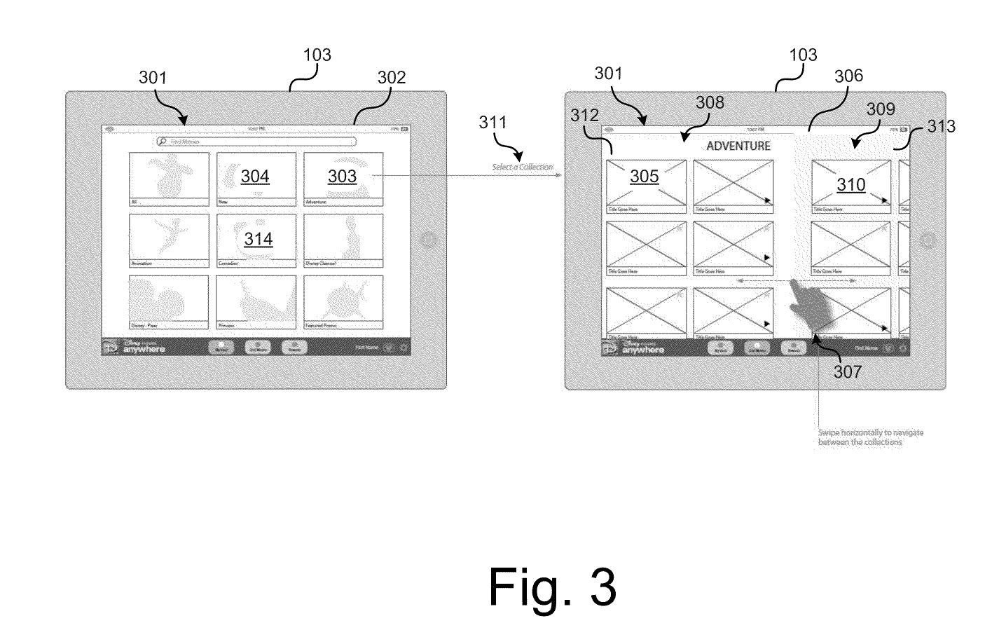

FIG. 3 illustrates a user interface with parallax scrolling. The GUI 301 is running on a user device 103 (FIG. 1), such as a tablet computer, and displayed on a screen of the user device 103. In a particular implementation, a host 104 (FIG. 1) on a network 102 delivers the GUI 301 and content displayed by the GUI 301. For example, the GUI 301 may be part of a website running within a browser running on the user device 103. As another example, the GUI 301 may be a specialized application or “app” running on a mobile device and capable of browsing content hosted by host 104. In another implementation, the GUI 301 may display locally stored content.

In the illustrated example, the GUI comprises a first screen 302 that displays a plurality of information collection assets 303, 304, 314. Information collection assets 303, 304 are delivered by host 104 and represent media available from host 104. In some implementations, the collection assets 303, 304, 314 may comprise hyperlinked images that lead to media collections. For example, the collection assets 303, 304, 314 may comprise images that represent categories of films, such as action films, animated films, romance films, classic films, or other categories.

The user is able to select a collection's asset 303, 304, 314 to access 311 a collection 308, 309. For example, clicking or tapping on collection asset 304 brings the user to a screen displaying collection 308. Collections 308, 309 each comprise a plurality of content elements 305, 310 and a background element 312, 313. In further embodiments, the collections 308, 309 may comprise further content layers, such as middle ground layers, having further collection elements.

The content elements 305, 310 may comprise hyperlinked images, icons, characters, movie elements, control elements, interaction elements, or other content elements. For example, the content elements 305, 310 may comprise thumbnail images for specific movies falling into the category associated with collection 308, 309. In some implementations, the user is able to interact with content elements 305, 310. For example, if content element 305 is a movie thumbnail, clicking or tapping on content element 305 may bring the user to a page that plays the movie.

The background elements 312, 313 comprise pictures, information elements, background patterns, or other elements displayed behind the content elements 305, 310. For example, the background element 312 for collection 308 may be a background picture having a theme relevant to the category associated with collection 308. In further implementations, the user may be able to interact with the background elements 312, 313. For example, the background layer may contain separate information or content. Users may be led to other screens by selecting this information or content.

The collections 308, 309 are displayed in a parallax scrolling GUI 306. The parallax scrolling GUI 306 provides a method for a user to switch between collections 308, 309. In the illustrated example, the user is able to switch between collections 308, 309 by providing a user input 307. For example, the user input 307 may comprise swiping horizontally, swiping vertically, tapping on a region of the display, tapping an icon, pressing a key, or performing some other input action.

When the user provides the input 307, the GUI 306 displays a parallax scrolling transition between the current collection 308 and the next collection 309. For example, if the user swipes in a horizontal direction, the GUI displays the next collection 309 in the direction of the horizontal swipe. In some implementations, if the user swipes in a vertical direction, the GUI 306 displays the next collection in vertical direction (i.e., the collection associated with asset 314). In some implementations, such as on iPad® and Android® tablets, this effect will allow parallax scrolling both horizontally and vertically. In other implementations, the effect may be restricted to only vertical or only horizontal scrolling. For example, the effect for the Web may only comprise vertical parallax scrolling. In some embodiments, parameters of the parallax scrolling transition may depend on the user input 307. For example, a fast swipe might create a fast parallax scrolling transition, while a slow swipe might create a slow parallax scrolling transition.

The parallax scrolling transition comprises translating the characters, objects 305, 310, background 312, 313, and other content layers at different speeds to provide an enriched visual experience. In a particular implementation, all elements are translated in the same direction. Elements are translated at decreasing speeds, where the forward-most elements (such as foreground images 305, 310) are translated faster than the back-most elements (such as background elements 312, 313). In this parallax scrolling effect, background images 312, 313, move by the camera slower than foreground images 305, 310, creating an illusion of depth in a 2D environment and adding to the immersion.

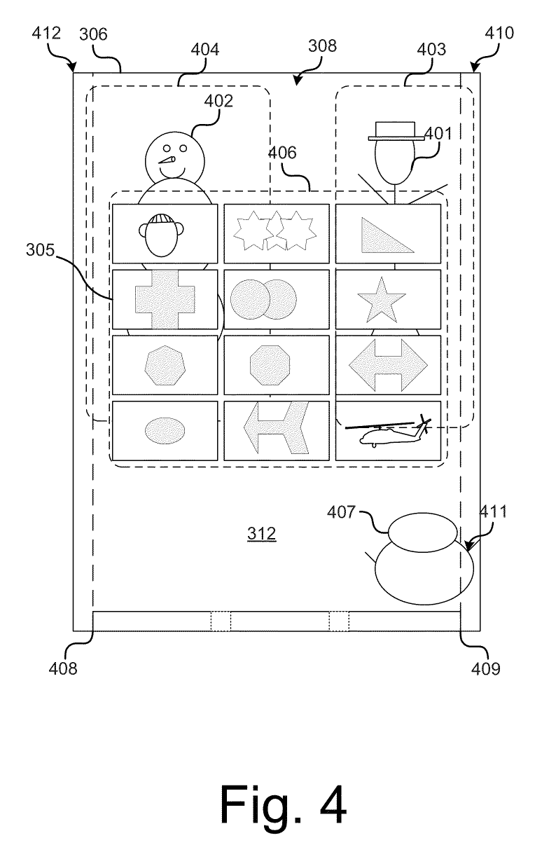

FIG. 4 illustrates further aspects of the GUI 306 from FIG. 3. The GUI 306 displays collection 308 (FIG. 3). The collection 308 comprises a foreground layer 406 comprising a plurality of content elements 305. In some implementations, the foreground layer 406 comprises a grid or list view, and the content elements 305 comprise tiles.

The collection 308 displayed by GUI 306 further comprises one or more middle ground layers 403, 404. The middle ground layers 403, 404 comprise middle ground elements 402, 401, respectively. For example, the middle ground elements 402, 401 may comprise graphics, characters, titles, or elements that can interact with the user. The collection 308 further comprises a background layer 312 comprising background elements 407. The user may use the GUI 306 to move from one collection 308 to another collection of content elements 309, for example by interacting with the regions defined by edges 408, 409 of the GUI, or by executing a gesture, such as a swipe, on the collection 308.

When the GUI 306 transitions from one collection 308 to a second collection 309, the elements 305, 401, 402, 407 in the GUI layers 406, 403, 404, 312 translate at different velocities to provide the user with a parallax effect, providing the illusion of depth. For example, in one transition, the foreground layer 406 translates to provide a second set of content elements 310 associated with a second collection 309. For example, the second set of content elements 310 may appear to translate from off-screen from edge 408 or 409. Simultaneously, the elements 401 and 402 of middle ground layers 403 and 404 translate to introduce new middle ground elements associated with the new collection 309. The elements 401, 402 each translate in the same direction as elements 305, 310, but with different velocities. Additionally, the background layer 207 translates to provide new background elements 208 for the new collection. The element 407 of background layer 312 translates with a fourth velocity. To provide the parallax effect, the elements 407 translate with a slower velocity than the middle ground elements 401, 402, which in turn translate with a slower velocity than the foreground elements 305. In some embodiments, the element 401 of middle ground layer 403 translates at a different speed than element 402 of middle ground layer 404. The middle ground layer 203 or 204, which translates slower, appears to be behind the faster middle ground layer 204 and 203. If the slower translation results in overlap of elements 401 and 402, the slower moving element is displayed behind the faster moving element. In one implementation, if a middle ground layer 403 contains a graphical element 401 that overlaps a graphical element 402 of another middle ground layer 404, then that middle ground layer 403 is selected to have the faster translation velocity.

In some implementations, the velocities of some or all of the elements 305, 401, 402, 407 may be determined based on a user input 307. For example, if the user input 307 is a swipe, or a mouse drag, the velocities of the elements 305, 401, 402, 407 may be determined based on the speed of swipe or mouse drag. As an example, a slow swipe may create a slowly moving parallax effect, creating the illusion that the elements 305 are moving slowly in front of background 312. Conversely, a fast swipe may create a rapidly moving parallax effect, creating the illusions that the elements 305 are moving rapidly in front of background 312. Additionally, the differences between the between the velocities of the elements 305, 401, 402, 407 may also vary according variations in the user input 307. In some implementations, the velocities are calculated in real time directly from the speed of the swipe or mouse drag. In other implementations, the velocities may be selected from a discrete number of predetermined velocities based on the user input 307.

Further implementations may have different numbers of middle grounds, for example, a GUI for a system with lower processing or graphical abilities might have no middle ground layers, or only a single middle ground layer. A system with higher processing or graphical abilities might have increased numbers of middle ground layers. For example, a GUI may have three or more middle ground layers. In a particular implementation, the collection title is implemented in its own layer. The tile layer may be a middle ground layer, or it may be a foreground layer that is in front of (i.e., has a faster translation velocity) than the content layer.

The GUI 306 further provides a bleeding or blending effect between the content of one collection 308 and the content of neighboring collections (such as collection 309). A transition region at a region of overlap 410 is defined by edge 409 and a region of overlap 412 is defined by edge 408. In some implementations, the locations and number of overlap regions is defined by the ability of the user to scroll between collections 308, 309, 314. For example, in an implementation allowing the user to scroll horizontally between collections 308, 309, two overlap regions 410, 412 may be defined at left and right edges of GUI 306. In an implementation allowing the user to scroll horizontally and vertically between collections 308, 309, 314, four overlap regions 410, 412 may be defined at all four edges of the GUI 306.

Within each region of overlap 410, 412, the graphical elements of neighboring collections transition into each other. For example, the region of overlap 410 may comprise a transparent overlay between element 407 from background layer 312 and elements from background layer 313 of collection 309. In a particular implementation, the transparent overlay is implemented as an opacity gradient. For example, at the left edge of region 410, the elements of collection 308 are 100% opaque, and the elements of collection 309 are 0% opaque. At the right edge of region 410, the elements of collection 308 are 0% opaque, and the elements of collection 309 are 100% opaque. In other implementations, the transitions in regions of overlap 410, 412 may be displayed using other effects, such as textural effects or blending effects.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method, comprising:
displaying a first collection of elements, the first collection of elements comprising a first content element, and a first background element;
receiving a user input to display a second collection of elements; and
displaying the second collection of elements, the second collection of elements comprising a second content element, and a second background element;
wherein the step of displaying the second collection of elements comprises:
translating the first content element and the second content element at a first velocity; and
translating the first background element and the second background element at a second velocity.

2. The method of claim 1, wherein:
the first collection of elements further comprises a first mid-ground element, and the second collection of elements further comprises a second mid-ground element; and
the step of displaying the second collection of elements comprises translating the first mid-ground element and the second mid-ground element at a third velocity.

3. The method of claim 2, wherein the first velocity is greater than the third velocity and the third velocity is greater than the second velocity.

4. The method of claim 1, wherein the first and second content elements comprise hyperlinks.

5. The method of claim 1, wherein the user input comprises a swipe primarily in the direction of the translation of the first and second content elements.

6. The method of claim 5, wherein the first velocity or the second velocity is calculated as a function of a speed of the swipe.

7. The method of claim 1, further comprising: displaying a transition region comprising at least a portion of an element from the first collection of elements and at least a portion of an element from the second collection of elements or at least a portion of an element from a third collection of elements.

8. The method of claim 7, wherein the transition region comprises a semi-transparent overlay of the at least a portion of the element from the first collection of elements and the at least a portion of the element from the second collection of elements or the at least a portion of an element from a third collection of elements.

9. A non-transitory computer readable medium comprising:
computer executable code configured to cause a computing device to perform a method, the method comprising:
displaying a first collection of elements, the first collection of elements comprising a first content element, and a first background element;
receiving a user input to display a second collection of elements; and
displaying the second collection of elements, the second collection of elements comprising a second content element, and a second background element;
wherein the step of displaying the second collection of elements comprises:
translating the first content element and the second content element at a first velocity; and
translating the first background element and the second background element at a second velocity.

10. The non-transitory computer readable medium of claim 9, wherein:
the first collection of elements further comprises a first mid-ground element, and the second collection of elements further comprises a second mid-ground element; and
the step of displaying the second collection of elements comprises translating the first mid-ground element and the second mid-ground element at a third velocity.

11. The non-transitory computer readable medium of claim 10, wherein the first velocity is greater than the third velocity and the third velocity is greater than the second velocity.

12. The non-transitory computer readable medium of claim 9, wherein the first and second content elements comprise hyperlinks.

13. The non-transitory computer readable medium of claim 9, wherein the user input comprises a swipe primarily in the direction of the translation of the first and second content elements.

14. The non-transitory computer readable medium of claim 13, wherein the first velocity or the second velocity is calculated as a function of a speed of the swipe.

15. The non-transitory computer readable medium of claim 9, further comprising: displaying a transition region comprising at least a portion of an element from the first collection of elements and at least a portion of an element from the second collection of elements or at least a portion of an element from a third collection of elements.

16. The non-transitory computer readable medium of claim 15, wherein the transition region comprises a semi-transparent overlay of the at least a portion of the element from the first collection of elements and the at least a portion of the element from the second collection of elements or the at least a portion of an element from a third collection of elements.

17. A method, comprising:
transmitting a first collection of elements to a computing device, the first collection of elements comprising a first content element, and a first background element;
transmitting a second collection of elements to the computing device, the second collection of elements comprising a second content element, and a second background element;
transmitting instructions to the computing device to cause the computing device to perform the steps of:
displaying the first collection of elements;
receiving a user input to display a second collection of elements; and
displaying the second collection of elements;
wherein the step of displaying the second collection of elements comprises:
translating the first content element and the second content element at a first velocity; and
translating the first background element and the second background element at a second velocity.

18. The method of claim 17, wherein:
the first collection of elements further comprises a first mid-ground element, and the second collection of elements further comprises a second mid-ground element; and
the step of displaying the second collection of elements comprises translating the first mid-ground element and the second mid-ground element at a third velocity.

19. The method of claim 18, wherein the first velocity is greater than the third velocity and the third velocity is greater than the second velocity.

20. The method of claim 19, wherein the first velocity or the second velocity is calculated as a function of a speed of the swipe.

21. The method of claim 17, wherein the first and second content elements comprise hyperlinks.

22. The method of claim 17, wherein the user input comprises a swipe primarily in the direction of the translation of the first and second content elements.

23. The method of claim 17, wherein the instructions further cause the computing device to perform the step of displaying a transition region comprising at least a portion of an element from the first collection of elements and at least a portion of an element from the second collection of elements.

24. The method of claim 23, wherein the transition region comprises a semi-transparent overlay of the at least a portion of the element from the first collection of elements and the at least a portion of the element from the second collection of elements.
